(19) United States
(12) Patent Application Publication
(10) Pub. No.: US 2013/0174062 A1
(43) Pub. Date: Jul. 4, 2013

(54) Method and Apparatus for Display Device

(71) Applicant: Asger Andreas Stoustrup, Copenhagen S (DK)

(72) Inventor: Asger Andreas Stoustrup, Copenhagen S (DK)

(73) Assignee: NOKIA CORPORATION, Espoo (FI)

(21) Appl. No.: 13/518,499

(22) PCT Filed: Dec. 23, 2009
(86) PCT No.: PCT/FI2009/051034

§ 371 Date: Nov. 16, 2012

(51) Int. Cl. G06F 3/0481

(52) U.S. Cl. CPC G06F 3/04817
USPC 715/761

(57) ABSTRACT

In accordance with an example embodiment of the present invention, there is provided an apparatus comprising: a processor, a first input device and a second input device, the first input device being configured to display a first icon and the second input device being configured to display a second icon. The processor being configured to detect an input on the first icon and to cause a movement of the first icon towards a perimeter of the first input device in response to the input and the processor being further configured to move the first icon from the first input device to the second input device.

### TECHNICAL FIELD

The present application relates generally to electronic devices, and more particularly to electronic display technology in electronic devices.

### BACKGROUND

Electronic devices are becoming more complex as time progresses, providing more functionality both through hardware and software. The drive towards having internet capable portable electronic devices has exploded in recent years. Portable electronic devices such as mobile phones, laptops, netbooks, and other similar portable devices having cameras, music players, games, internet browsers, navigation capabilities, and video functionality requiring one or more electronic display to view output coming from these functions and/or providing input for these functions. Further these devices provide both simple and complex mechanical configurations for providing these functionalities such as simple monoblock or candybar mechanical housings, folding mechanics or housings, sliding housings or even twisting housings and combinations thereof have been seen in recent years. There is a continual desire and drive to provide even further combinations of these aforementioned functionalities and configurations for improved usability of such devices.

### SUMMARY

According to various, but not necessarily all, embodiments of the present invention there is provided an apparatus comprising: a processor, a first input device and a second input device, the first input device being configured to display a first icon and the second input device being configured to display a second icon. The processor being configured to detect an input on the first icon and to cause a movement of the first icon towards a perimeter of the first input device in response to the input and the processor being further configured to move the first icon from the first input device to the second input device.

According to various, but not necessarily all, embodiments of the present invention there is provided a method comprising: providing a first input device being configured to display a first icon and a second input device being configured to display a second icon, displaying the first icon on the first input device, detecting an input on the first icon and causing a movement of the first icon towards a perimeter of the first input device in response to the input, and moving the first icon from the first input device to the second input device.

According to various, but not necessarily all, embodiments of the present invention there is provided an apparatus, comprising: a first input device being configured to display a first icon, at least one processor, and at least one memory including computer program code. The at least one memory and the computer program code being configured to, with the at least one processor, cause the apparatus to perform at least the following: detection of an input on the first input device; movement of the first icon towards a perimeter of the first input device in response to the input; and movement of the first icon from the first input device to a second input device.

According to various, but not necessarily all, embodiments of the present invention there is provided a computer program, comprising: code for detecting an input on a first input device, the first input device being configured to display a first icon, code for moving the first icon towards a perimeter of the first input device in response to the input, and code for transferring the first icon from the first input device to a second input device, when the computer program is run on a processor.

According to various, but not necessarily all, embodiments of the present invention there is provided a computer-readable medium encoded with instructions that, when executed by a computer, perform: detection of an input on a first icon being configured to be displayed on the first input device; movement of the first icon towards a perimeter of the first input device in response to the input, and movement of the first icon from the first input device to a second input device, the second input device being configured to display the first icon.

According to various, but not necessarily all, embodiments of the present invention there is provided an apparatus comprising: means for processing, means for detecting an input on a first input device, on a first icon displayed on the first input device, the first input device comprising displaying means for displaying at least the first icon, means for moving the first icon towards a perimeter of the first input device in response to the input, and means for moving the first icon from the first input device to a second input device, the second input device comprising displaying means for displaying at least the first icon.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a schematic diagram of an apparatus according to various embodiments of the present invention;

FIGS. 2a, 2b and 2c illustrate a plan view of an apparatus according to various embodiments of the present invention;

FIGS. 3a, 3b, 3c, 3d, 3e and 3f illustrate a plan view of an apparatus according to various embodiments of the present invention;

FIGS. 4a, 4b and 4c illustrate a plan view of an apparatus according to various embodiments of the present invention;

FIGS. 5a, 5b, 5c and 5d illustrate a perspective view of an apparatus according to various embodiments of the present invention;

FIGS. 6a, 6b, 6c and 6d illustrate a perspective view of an apparatus according to various embodiments of the present invention;

FIGS. 7a and 7b illustrate a perspective view of an apparatus according to various embodiments of the present invention;

FIG. 8 is a flow diagram of a method of performing the movement of an icon displayed on an apparatus according to various embodiments of the present invention.

### DETAILED DESCRIPTION OF THE DRAWINGS

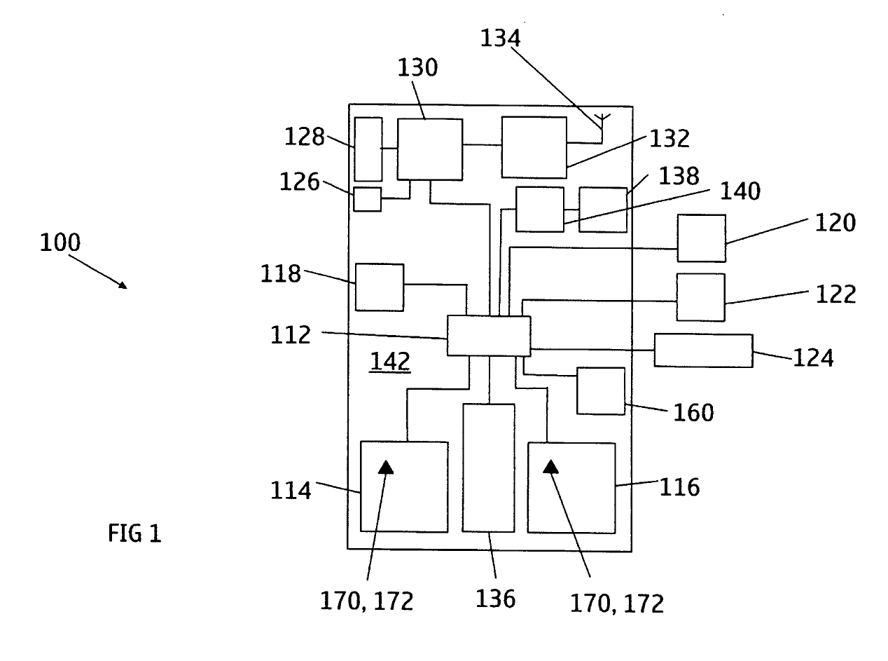

Example embodiments of the present invention and its potential effects are understood by referring to FIGS. 1 through 8 of the drawings.

Example embodiments of the present invention are directed towards providing an apparatus comprising a processor, a first input device and a second input device. The first input device is configured to display a first icon and the second input device is configured to display a second icon. The processor is configured to detect an input on the first icon and to cause a movement of the first icon towards a perimeter of the first input device in response to the input, and the processor is further configured to move the first icon from the first input device to the second input device.

FIG. 1 illustrates an apparatus 100 such as a portable electronic device, for example, a mobile cellular telephone, a personal digital assistant or any hand held computer or a module for such devices. As used here, ‘module’ refers to a unit or apparatus that excludes certain parts/components that would be added by an end manufacturer or a user.

The apparatus 100 comprises a processor 112, which may be any processor or computer device with a control unit which may perform control based on software routines of a control program stored in an internal memory 118, for example and not limited to, random access memory (RAM) or read only memory (ROM), and/or external memory or storage devices, such as a hard disc drive 120, a disc-based medium 122 (such as for example a floppy disc or CD-ROM (Compact Disc Read Only Memory) or DVD-ROM (Digital Versatile Disc ROM), or a memory stick 124. Program code instructions may be fetched from at least one of the internal or external memories 118, 120, 122, 124 and may be loaded to the control unit of the processor 112 in order to perform processing of various functionalities described hereinafter. The processing may be performed on the basis of input data and may generate output data, where the input data may correspond to input data from any of the devices of the apparatus 100 and the output data may correspond to output data for controlling any of the devices, or sending output data to any of the devices of the apparatus 100. Although memory is described herein in the various exemplary embodiments, as being either internal or external to the apparatus 100, it should be appreciated that any memory device 118, 120, 122, 124 may be disposed internally or externally to the apparatus 100.

FIG. 1 further illustrates other example components of the apparatus 100, the apparatus 100 may further comprise a first input device 114, a second input device 116, and a third input device 160 which may be, and not limited to, keyboards, keypads or other input devices, such as touch display screens, mechanical switches, and slide switches, for example. The first input device 114 may be a touch display screen, a touch input providing a data input to the processor 112. Although the first input device 114 is described herein as an input device, it may also provide an output function such as that provided by a touch display screen, displaying data on the first input device 114 to a user of the apparatus 100. The second input device 116 may be a mechanical keyboard comprising a plurality of mechanical hard keys, for example. The second input device 116 may also be a touch input device providing the same functionality as the first input device 114 functioning as a touch display screen, as described above. The first input device 114 may be configured to display a first icon 170 and a second icon 172, and the second input device 116 may be configured to display a first icon 170 and a second icon 172. The first and second icons 170, 172 are illustrated as black triangles in FIG. 1. The apparatus 100 may also be configured to display more than the first and second icons, and a plurality of icons may be displayed on the at least first, second and third input devices 114, 116, 160.

The apparatus 100 may comprise a microphone 126 for providing an audio input, functional circuitry 130, such as analogue and digital baseband and audio processing circuitry, and a loudspeaker 128 for providing an audio output. The apparatus 100 may also comprise radio frequency circuitry 132 for providing radio frequency processing of signals associated with wireless radio functionality such as that of receiver front-ends for receiving radio frequency signals and transmitter chains for transmitting radio frequency signals of a wireless radio air interface, and an antenna or antennas 134 for providing the capability of receiving and transmitting electromagnetic radio frequency signals over the wireless radio air interface. There may be one or more radio frequency circuits 132 disposed in the apparatus 100 for enabling radio access to a plurality of radio protocols or standards, such as the following non limiting examples: EGSM (Extended Global System for Mobile communications), BT (Bluetooth), GPS (Global Positioning System), FM (Frequency Modulation), etc. The apparatus 100 may comprise a power source 136, which may be one or more of: a single cell or an arrangement of cells forming a battery, an external power source such as a battery charger, inductive charger, solar cell or cells or a mains power supply. The apparatus 100 may also comprise a camera 138 for taking images or photographs and/or videos, and image processing circuitry 140 for processing images and video taken by the camera 138. Some or all of the components described herein with reference to FIG. 1, may be interconnected via a printed wiring board 142 (PWB), in various embodiments the PWB may provide a ground plane for the antenna 134. The processor 112 may also be disposed anywhere in the apparatus 100, for example, it may be disposed on the printed wiring board 142, the printed wiring board 142 being disposed in any part or sub-part of the apparatus 100, or the processor 112 may be integrated with another component, for example, the functional circuitry 130. This list of components typically found in portable electronic devices is non-exhaustive and there may be other components not described herein which are omitted for the sake of clarity.

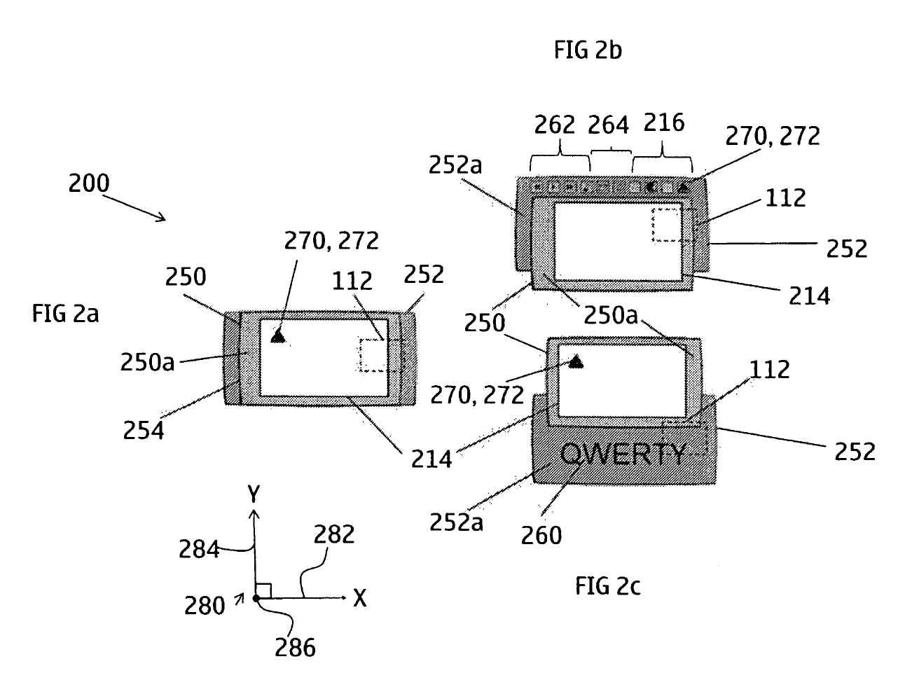

FIGS. 2a, 2b and 2c illustrate a plan view of an apparatus 200 according to various embodiments of the present invention. The apparatus 200 is configured to be a slideable apparatus, comprising a first housing 250 and a second housing 252, the first housing 250 configured to slide relative to the second housing 252. FIGS. 2a, 2b and 2c also illustrate a Cartesian co-ordinate system 280 including an X axis 282, a Y axis 284 and a Z axis 286 that are orthogonal to one another. The Z axis 286 is drawn as a dot and represents an axis going into or out of the page. In the example embodiment the first housing 250 is configured to slide relative to the second housing 252 in two directions in a first plane (the XY plane).

FIG. 2a, illustrates a first configuration of the apparatus 200. The first housing 250 is positioned substantially over the second housing 252 in the XY plane. The first housing 250 comprises a first input device 214 disposed at a first surface 250a of the first housing 250, which may be a touch display screen having a touch responsive input capability.

FIG. 2b illustrates a second configuration of the apparatus 200. The first housing 250 is configured to slide relative to the second housing 252 in the −Y direction, until the first housing 250 reveals a second input device 216 disposed at a first surface 252a of the second housing 252. The second input device 216 may be an arrangement of one or more mechanical hard keys disposed on a first surface of the second housing 252. The mechanical hard keys may be capable of displaying icons, for example, they may have an integrated miniature electronic display device or module for displaying icon sized graphical objects. Alternatively, the apparatus 200 may comprise a second input device 216 which is a second touch display screen, different to the first touch display screen or first input device 214, in combination with one or more mechanical hard keys disposed on a first surface of the second housing 252. FIG. 2b illustrates music hard keys 262 used for music functions in an electronic music playing device and messaging hard keys 264 used for messaging applications (email, SMS/text, social networking applications, etc) disposed on a first surface 252a on the second input device 216. The music and messaging keys 262, 264 may also be disposed on a touch display screen, instead of using traditional mechanical hard key technology.

FIG. 2c illustrates a third configuration of the apparatus 200. The first housing 250 is configured to slide relative to the second housing 252 in the +Y direction, as illustrated in FIG. 2b, until the first housing 250 reveals a third input device 260. The third input device 260 may be a full QWERTY keyboard disposed on a first surface 252a of the second housing 252. The QWERTY keyboard may be used by the user of the apparatus 200 for generating input data for the processor 112, as an alternative way of generating input data to that of the first and second input devices 214, 216. The third input device 260 may be another form of input device, for example, an alphanumeric keypad as found on mobile phones and the like.

In FIGS. 2a, 2b and 2c, the first input device 214 is always visible, but in the second configuration of the apparatus 200 as illustrated in FIG. 2b only the first and second input devices 214, 216, are visible and in the third configuration of the apparatus 200 as illustrated in FIG. 2c only the first and third input devices 214, 260, are visible to the user of the apparatus 200. In the first configuration of the apparatus 200 as illustrated in FIG. 2a, only the first input device 214 is visible to the user of the apparatus 200, the second and third input devices 216, 260 configured to be hidden from view by the first housing 250.

The apparatus 200 further comprises a mechanism 254 between the first housing 250 and the second housing 252 configured to move at least one of the first and second housings 250, 252 relative to the other of the at least one of the first and second housings 250, 252 between a first configuration and a second configuration of the apparatus 200.

In FIGS. 2a, 2b, and 2c, the first input device 214 is configured to display a first icon 270 to the user of the apparatus 200 in any of the first, second and third configurations. In various embodiments the first icon 270 may be an actuable icon, that is, the first icon 270 may be selectable by the user, and other alternative actions may be performed on the first icon 270, for example, copy, paste, cut, delete and move actions, as an unexhausted exemplary list of possible actions.

In various embodiments of the present invention the first input device 214 may be a touch display device, and when the user of the apparatus 200 touches the first input device 214, the user is able to perform various actions on at least the first icon 270. The user may wish to move the first icon 270 to a second input device 216 so as to free up space on the first input device 214 for other functions or displaying requirements. The first icon 270 may be any graphical representation of data or information displayed on an electronic display such as the example touch display device, for example, the first icon 270 could be only text, or it could be an image or a combination of text and image. The first icon 270 may be representative of a piece of software code, an executable program or a widget, for example a software application such as a music player or an internet browser. The first icon 270 may be a defined key for a software application, for example, “play”, “pause”, “fast forward” in an imaging or audio related application.

The first icon 270 may be passive, in other words the first icon 270 may not be actively running any executable code, software or program on the processor 112 yet and may only indicate a program which may be executed by the user of the apparatus 200. On the other hand the first icon 270 may be active and therefore representative of an actively running program, widget or batch of executed programming code. When the first icon 270 is active, the first icon 270 is configured to be displayed on at least one of the first and second input devices 214, 216, and the first icon 270 may provide information or data which changes with respect to time. This information or data which changes with respect to time may only provide a graphical change, for example, an animation, or it may provide new data, for example, a clock face, news flashes or a weather report and the like.

In various embodiments of the present invention, the processor 112 is configured to detect an input on the first input device 214, the input being in this example, a result of the user using his or her finger or a pointer tool to select and physically move the icon towards a perimeter of the first input device 214. The processor 112 is configured to cause a movement of the first icon 270 towards a perimeter of the first input device 214, and the processor 112 is further configured to move the first icon 270 from the first input device 214 to a second input device 216. This action frees up space on the first input device 214 to display other icons or to not display anything at all, the first icon 270 may still be needed by the user whilst performing other actions on the first input device 214. For example, this gives the effect that the user may wish to play a game displayed on the first input device 214 whilst maintaining visibility of a widget, or first icon 270, on the second input device 216. The widget or first icon 270, for example, may provide realtime weather information or news flashes.

In an alternative example embodiment where the second input device 216 is only a mechanical hard key, the user may only need to press the mechanical hard key and hold it in, for example, for a few seconds in order to perform the action of requesting the first icon 270 to be moved from the second input device 216 to the first input device 214. The processor 112 configured to detect the input from the second input device 216, the processor 112 configured to cause a movement of the first icon 270 from the second input device 216 to the first input device 214.

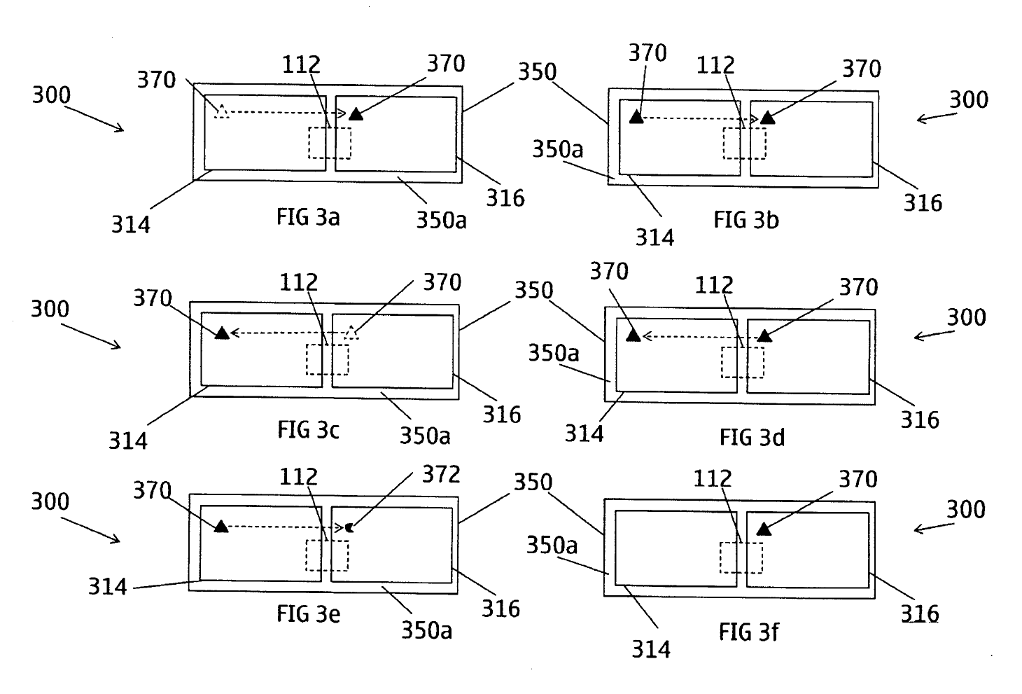

FIGS. 3a, 3b, 3c, 3d, 3e and 3f illustrate a plan view of an apparatus 300 according to various embodiments of the present invention. FIGS. 3a, 3b, 3c, 3d, 3e and 3f illustrate an apparatus 300 comprising a first housing 350, and in this example embodiment, the apparatus 300 comprises a first input device 314 and a second input device 316 arranged in a substantially co-planar arrangement on a first surface 350a of the first housing 350.

The first input device 314 may be configured to display a first icon 370. A processor 112 may be configured to move the first icon 370 from the first input device 314 to the second input device 316, as illustrated in FIG. 3a. The first icon 370 is illustrated as a dotted triangle to show that it was displayed initially on the first input device 314. The first icon 370 is then illustrated as a black triangle when displayed on the second input device 316 to show that it has moved from the first input device 314 to the second input device 316, the dotted arrow illustrating the movement.

FIG. 3b illustrates an example embodiment where the first input device 314 may be configured to display a first icon 370. A processor 112 may be configured to copy the first icon 370 from the first input device 314, and move or paste the first icon 370 to the second input device 316. The first icon 370 displayed on the first input device 314 is illustrated as a black triangle to show that it remains displayed on the first input device 314. The first icon 370 displayed on the second input device 316 is also illustrated as a black triangle when displayed on the second input device 316 to show that it has moved from the first input device 314 to the second input device 316, the dotted arrow illustrating the movement.

FIG. 3c illustrates an example embodiment where the second input device 316 may be configured to display a first icon 370. A processor 112 may be configured to move the first icon 370 from the second input device 316 to the first input device 314. The second icon 370 is illustrated as a dotted triangle to show that it was displayed initially on the second input device 316. The first icon 370 is then illustrated as a black triangle when displayed on the first input device 314 to show that it has moved from the second input device 316 to the first input device 314, the dotted arrow illustrating the movement. FIG. 3c illustrates that the first icon 370, or any icon, displayed on the second input device 316 may be moved to the first input device 314.

FIG. 3d illustrates an example embodiment where the second input device 316 may be configured to display a first icon 370. A processor 112 may be configured to copy the first icon 370 from the second input device 316, and move or paste the first icon 370 to the first input device 314. The first icon 370 displayed on the second input device 316 is illustrated as a black triangle to show that it remains displayed on the second input device 316. The first icon 370 displayed on the first input device 314 is also illustrated as a black triangle when displayed on the first input device 314 to show that it has moved from the second input device 316 to the first input device 314, the dotted arrow illustrating the movement. FIG. 3d illustrates that the first icon 370, or any icon, displayed on the second input device 316 may be copied and then pasted to the first input device 314 with the first icon 370 being displayed on both the first and second input devices 314, 316.

FIG. 3e illustrates an example embodiment where the first input device 314 may be configured to display a first icon 370, and the second input device 316 may be configured to display a second icon 372. The processor 112 may be configured to replace the second icon 372 displayed on the second input device 316 with the first icon 370 from the first input device 314. FIG. 3f further illustrates the embodiment of FIG. 3e once the replacement of icons has taken place. The second input device 316 is now configured to display the first icon 370 which has replaced the second icon 372. The first input device 314 may no longer be configured to display the first icon 370.

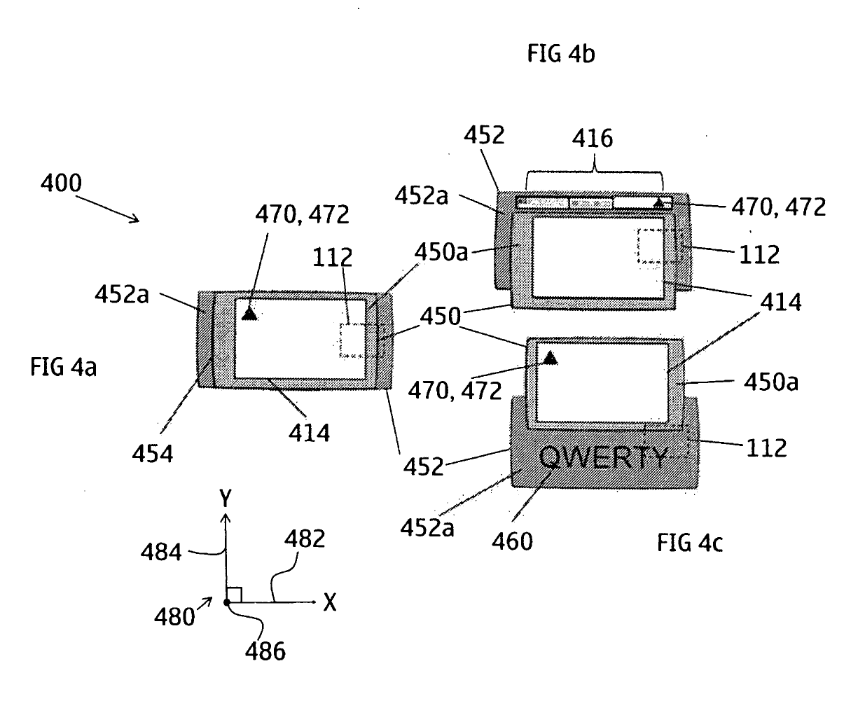

FIGS. 4a, 4b and 4c illustrate a plan view of an apparatus 400 according to various embodiments of the present invention. The apparatus 400 comprises a first input device 414 disposed at a first surface 450a of a first housing 450, and a second input device 416 disposed at a first surface 452a of a second housing 452. The second input device 416 in this example embodiment may be a second touch display screen 416. The second input device 416 is configured to display icons and other data or information to the user, and to detect an input from a user of the apparatus 400. FIGS. 4a, 4b and 4c also illustrate a Cartesian co-ordinate system 480 including an X axis 482, a Y axis 484 and a Z axis 486 that are orthogonal to one another. The Z axis 486 is drawn as a dot and represents an axis going into or out of the page. In the example embodiment the first housing 450 is configured to slide relative to the second housing 452 in two directions in a first plane (the XY plane).

FIG. 4a, illustrates a first configuration of the apparatus 400. The first housing 450 is positioned substantially over the second housing 452 in the XY plane. The first housing 450 comprises a first input device 414, which may be a touch display screen having a touch responsive input capability and a display output capability. The apparatus 400 further comprises a mechanism 454 between the first housing 450 and the second housing 452 configured to move the first housing 450 relative to the second housing 452.

According to FIGS. 4a, 4b and 4c, in various embodiments of the present invention, when the apparatus 400 is in any one of the first, second and third configurations, the processor 112 is configured to detect an input on the first input device 414. The first and second input devices 414, 416 may both be touch display screens. A first icon 470 may be moved from the first input device 414 to the second input device 416, where a second icon 472 displayed on the second input device 416 may be replaced by the first icon 470. The processor 112 is configured to detect an input on the first input device 414 and to replace the second icon 472 with the first icon 470 on the second input device 416. The input being a result of the user using his or her finger or a pointer tool to select and physically move a first icon 470 towards a perimeter of the first input device 414. The processor 112 is configured to cause a movement of the first icon 470 towards a perimeter of the first input device 414, and the processor 112 is further configured to move the first icon 470 from the first input device 414 to the second input device 416. This gives the effect that the action frees up space on the first input device 414 to display other icons or to not display anything at all, the first icon 470 may be needed by the user whilst performing other actions on the first input device 414. If the user wishes to close the apparatus 400 so that the apparatus 400 is now in the first configuration, the user may wish to have neither the first or second icons 470, 472 present on the first input device 414, the user may wish to hide the icons from view altogether when in the first configuration. For example, the first or second icons 470, 472 may be moved from the first input device 414 to a second input device 416 so that the icons are still displayed on the second input device 416, but the second input device 416 is not visible to the user when the apparatus 400 is in the first configuration.

Alternatively the processor 112 is configured to move the first icon 470 from the first input device 414 to the second input device 416, and to display both the first icon 470 and the second icon 472 on the second input device 416. The processor 112 is further configured to display the second icon 472 on the second input device 416 before the first icon 470 is moved to the second input device 416. In both cases the processor 112 is configured to transfer the first icon 470 from the first input device 414 to the second input device 416, or from the second input device 416 to the first input device 414.

FIG. 4b illustrates a second configuration of the apparatus 400, according to various embodiments of the present invention. The first housing 450 is configured to slide relative to the second housing 452 in the −Y direction, as illustrated in FIG. 4b, until the first housing 450 reveals the second input device 416. When the apparatus 400 is in the second configuration the processor 112 is configured to detect an input on the second input device 416, where the second input device 416 may be a touch display screen. The input being a result of the user using his or her finger or a pointer tool to select and physically move a second icon 472 towards a perimeter of the second input device 416. The processor 112 is configured to cause a movement of the second icon 472 towards a perimeter of the second input device 416 in response to the input, and the processor 112 is further configured to move the second icon 472 from the second input device 416 to the first input device 414. This gives the effect that the action frees up space on the second input device 416 to display other icons or to not display anything at all, the second icon 472 may be needed by the user, and displayed on the first input device 414 whilst performing other actions on the first input device 414. If the user wishes to close the apparatus 400 so that the apparatus 400 is now in the first configuration, the user may wish to have the second icon 472 present on the first input device 414 for viewing or for some other action. As previously described above, the second icon 472 may be transferred from the second input device 416 to the first input device 414, or the second icon 472 may replace a first icon 470 on the first input device 414.

FIG. 4c illustrates a third configuration of the apparatus 400. The first housing 450 is configured to slide relative to the second housing 452 in the +Y direction, as illustrated in FIG. 4b, until the first housing 450 reveals a third input device 460. The third input device 460 may be a full QWERTY keyboard disposed on a first surface 452a of the second housing 452. The QWERTY keyboard may be used by the user of the apparatus 400 for generating input data for the processor 112, as an alternative way of generating input data to that of using the first and second input devices 414, 416. The third input device 460 may be another form of input device, for example, an alphanumeric keypad as found on mobile phones and the like.

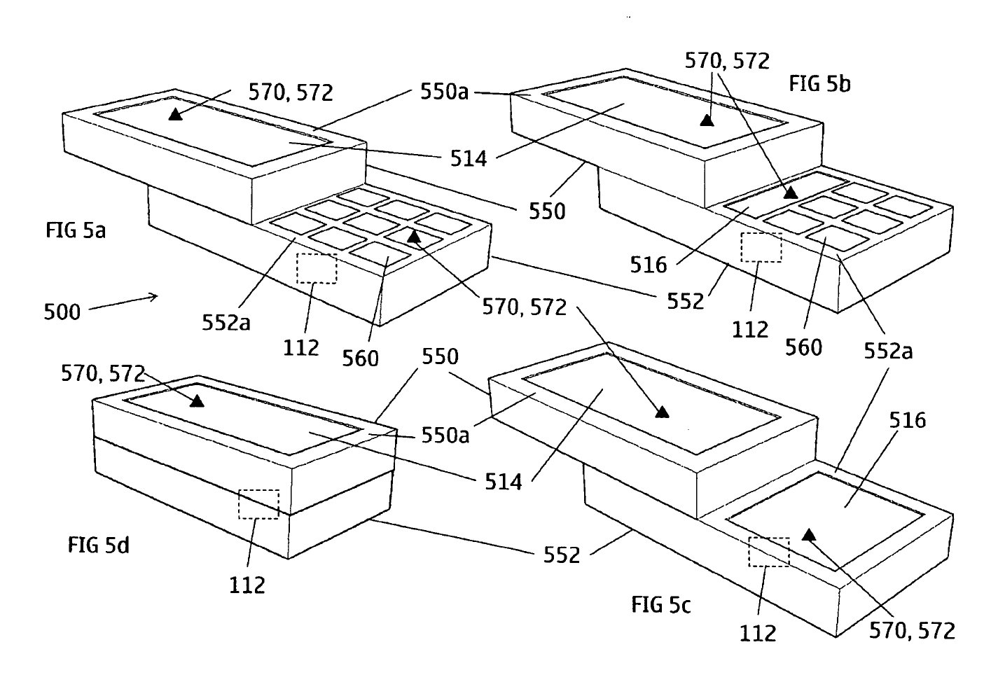

FIGS. 5a, 5b, 5c and 5d illustrate a perspective view of an apparatus 500 according to various embodiments of the present invention. The apparatus 500 comprises a first housing 550 and a second housing 552. The apparatus 500 in FIGS. 5a, 5b and 5c is similar to the apparatus 200 of FIGS. 2a, 2b, 2c, and the apparatus 400 of FIGS. 4a, 4b and 4c, as the apparatus 500 is configured to be slideable such that the first housing 550 may be configured to slide relative to the second housing 552 from a first or open configuration to a second or closed configuration, or from a second configuration to a first configuration. FIGS. 5a, 5b and 5c illustrate the apparatus 500 in the first configuration. FIG. 5d illustrates the apparatus 500 in the second configuration.

FIG. 5a illustrates an apparatus 500 comprising a first input device 514 disposed on a first surface 550a of the first housing 550, and a third input device 560 disposed on a first surface 552a of the second housing 552. The third input device 560 may comprise at least one mechanical hard key. In FIG. 5a, the third input device 560 is illustrated as a grid arrangement of nine mechanical hard keys, but this number of keys could be more or less than nine dependent on apparatus 500 design requirements.

FIG. 5b illustrates an alternative example embodiment of an apparatus 500 comprising a first input device 514 disposed on a first surface 550a of the first housing 550, and a second input device 516 disposed on a first surface 552a of a second housing 552 and a third input device 560 disposed on the first surface 552a of the second housing 552. The third input device 560 may be required for other input functionality such as writing text messages or emails, and the second input device 516 may be a touch responsive or a non-touch responsive display.

FIG. 5c illustrates a further alternative example embodiment of an apparatus 500 comprising a first input device 514 disposed on a first surface 550a of the first housing 550 and a second input device 516 disposed on a first surface 552a of the second housing 552.

As illustrated in the example embodiment of FIG. 5d when the apparatus 500 is in the second configuration the first input device 514 is visible to the user of the apparatus 500. When the apparatus 500 is in the first configuration, as shown in FIGS. 5a, 5b, and 5c the first input device 514 is visible to the user. In the example embodiments of FIGS. 5b and 5c the second input device 516 may only be visible to the user in the first configuration of the apparatus 500.

According to FIGS. 5a, 5b, 5c and 5d, in various embodiments of the present invention, when the apparatus 500 is in either the first or second configuration the processor 112 is configured to detect an input on the first input device 514, where the first input device 514 may be a touch display screen. The input being a result of the user using his or her finger or a pointer tool to select and physically move a first icon 570 towards a perimeter of the first input device 514. The processor 112 is configured to cause a movement of the first icon 570 towards a perimeter of the first input device 514 in response to the input, and the processor 112 is further configured to move the first icon 570 from the first input device 514 to the second input device 516. This gives the effect that the action frees up space on the first input device 514 to display other icons or to not display anything at all, the first icon 570 may be needed by the user whilst performing other actions on the first input device 514. If the user wishes to close the apparatus 500 so that the apparatus 500 is now in the first configuration, the user may wish to have the first icon 570 removed from the first input device 514 for another software application or for some other action. As previously described above, in the first or second configuration of the apparatus 500 the first icon 570 may be transferred from the first input device 514 to the second input device 516, or the first icon 570 may replace a second icon 572 on the second input device 516.

According to FIGS. 5a, 5b, and 5c, in various embodiments of the present invention, when the apparatus 500 is in the second configuration the processor 112 is configured to detect an input on the second input device 516, where the second input device 516 may be a touch display screen. The input being a result of the user using his or her finger or a pointer tool to select and physically move a second icon 572 towards a perimeter of the second input device 516. The processor 112 is configured to cause a movement of the second icon 572 towards a perimeter of the second input device 516 in response to the input, and the processor 112 is further configured to move the second icon 572 from the second input device 516 to the first input device 514. This gives the effect that the action frees up space on the second input device 516 to display other icons or to not display anything at all, the second icon 572 may be needed by the user whilst performing other actions on the first input device 514. If the user wishes to close the apparatus 500 so that the apparatus 500 is now in the first configuration, as illustrated in FIG. 5d, the user may wish to have the second icon 572 present on the first input device 514 for viewing or for some other action. As previously described above, the second icon 572 may be transferred from the second input device 516 to the first input device 514, or the second icon 572 may replace a first icon 570 on the first input device 514. As illustrated in FIG. 5a, the input may alternatively be as a result of the user pressing one of the at least one mechanical hard keys 560 in for a number of seconds, the “press and hold” action providing the command or input to move the second icon 572 from the third input device 560 to the first input device 514. In FIG. 5a, the third input device 560 may be configured to display a first or second icon 570, 572.

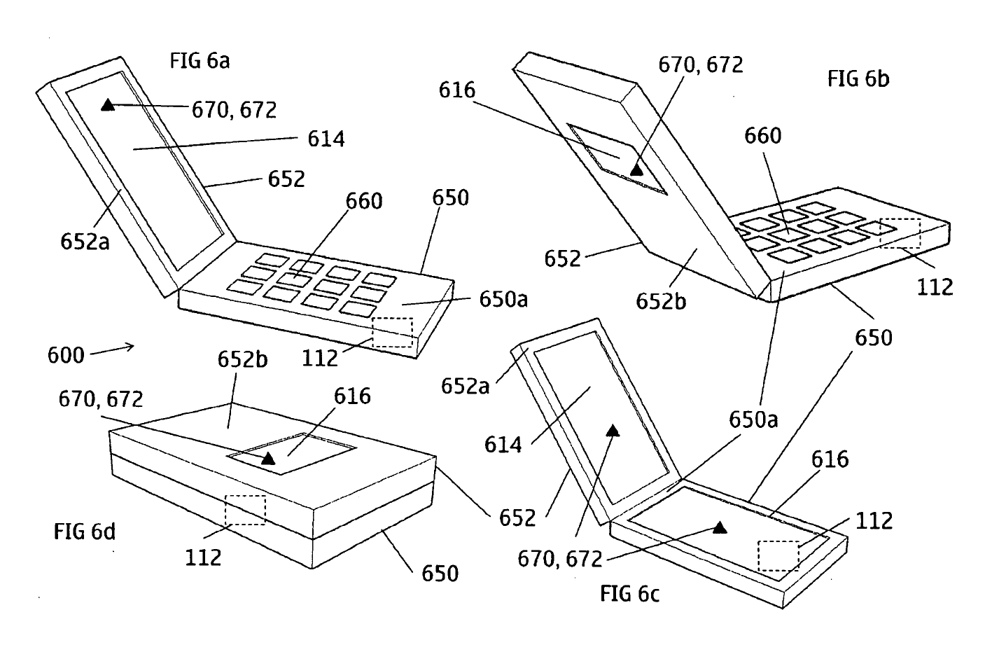

FIGS. 6a, 6b, 6c and 6d illustrate a perspective view of an apparatus 600 according to various embodiments of the present invention. The apparatus 600 comprises a first housing 650 and a second housing 652. The apparatus 600 is configured to fold about an axis of rotation such that the first housing 650 may be configured to rotate relative to the second housing 652 from a first configuration to a second configuration, or from a second configuration to a first configuration. The first configuration may be an open configuration, in other words, the first housing 650 is opened up from or rotated relative to the second housing 652 so that at least a first surface 650a of the first housing 650 does not substantially face a first surface 652a of the second housing 652. The second configuration may be a closed configuration, in other words, the first housing 650 is closed so that at least a first surface 650a of the first housing 650 substantially faces the first surface 652a of the second housing 652. FIGS. 6a, 6b and 6c illustrate the apparatus 600 in the first or open configuration. FIG. 6d illustrates the apparatus 600 in the second or closed configuration.

FIGS. 6a and 6b, illustrate a first housing 650 comprising a third input device 660, where the third input device 660 is an arrangement of mechanical hard keys. The first input device 614 is disposed on a first surface 652a of the second housing 652 and the third input device 660 is disposed on a first surface 650a of the first housing 650. The second input device 616 is disposed on a second surface 652b of the second housing 652, the second surface 652b configured to be substantially parallel to the first surface 652a of the second housing 652. When the apparatus 600 is in the closed configuration the first input device 614 may not be visible by the user of the apparatus 600. When the apparatus 600 is in the open configuration, as shown in FIGS. 6a, 6b and 6c, the first input device 614 may be visible by the user. The second input device 616 may be visible in both closed and open configurations of the apparatus 600 as illustrated in FIGS. 6b and 6d.

FIG. 6c illustrates an apparatus 600 according to various embodiments of the present invention, the apparatus 600 in the second configuration. The first housing 650 is configured to rotate relative to the second housing 652 until the first and second housings 650, 652 reveal the first and third input devices 614, 660 in the second configuration. The second input device 616 may be a touch display screen disposed on a second surface 652b of the second housing 652. The third input device 660 may comprise an arrangement of mechanical hard keys and may be used for providing data input to the apparatus 600 such as text and numerical characters.

FIG. 6d illustrates the closed or first configuration of the apparatus 600. The third input device 660 and the first input device 614 may no longer be visible to the user in the first configuration.

In FIGS. 6a, 6b and 6c, the first input device 614 is always visible, but in the first configuration of the apparatus 600 as illustrated in FIG. 6d only the second input device 616 is visible. In the first configuration of the apparatus 600 as illustrated in FIG. 6d, only the second input device 616 is visible to the user of the apparatus 600, the first and third input devices 614, 660 configured to be hidden from view by the first and second housings 650, 652. The user may wish to move a first or second icon 670, 672, for example, from the second input device 616 to the first input device 614, so that there are no icons displayed on the second input device 616 when the apparatus 600 is in the first configuration.

In FIGS. 6a, 6b, and 6c, the first input device 614 is configured to display a first icon 670 to the user of the apparatus 600 in the second configuration. In various embodiments the first icon 670 may be an actuable icon, that is, the first icon 670 may be selectable by the user, and other alternative actions may be performed on the first icon 670, for example, copy, paste, cut, delete and move actions, as an unexhausted exemplary list of possible actions.

In various embodiments of the present invention the first input device 614 may be a touch display device, and when the user of the apparatus 600 touches the first input device 614, the user is able to perform various actions on at least the first icon 670. The user may wish to move the first icon 670 to a second input device 616 so as to free up space on the first input device 614 for other functions or displaying requirements. The first icon 670 may be any graphical representation of data or information displayed on an electronic display such as the example touch display device, for example, the first icon 670 could be only text, or it could be an image or a combination of text and image. The first icon 670 may be representative of an executable program or widget, the first icon 670 may be passive, in other words the first icon 670 may not be running any code or program yet and may only indicate a program which could be executed, or the first icon 670 may be active and therefore representative of an actively running program or batch of executed programming code.

In various embodiments of the present invention, the processor 112 is configured to detect an input on the first input device 614, the input being in this example, a result of the user using his or her finger or a pointer tool to select and physically move the icon towards a perimeter of the first input device 614. The processor 112 is configured to move the first icon 670 from the first input device 614 to the second input device 616. This action frees up space on the first input device 614 to display other icons or to not display anything at all, the first icon 670 may still be needed by the user whilst performing other actions on the first input device 614. For example, the user may wish to play a game displayed on the first input device 614, but before executing the game application the user may wish to move a widget or first icon 670 to the second input device 616 so as to free space on the first input device 614 solely for the game. The widget or first icon 670, for example, may provide realtime weather information or news flashes to which the user may wish to periodically view from the second input device 616, for example, whilst playing the game on the first input device 614.

FIG. 6c illustrates the second input device 616 disposed on a first surface 650a of the first housing 650. The second input device 616 may be a touch display device, and the first input display device 614 may be disposed on a first surface 652a of the second housing 652. The first input device 614 and the second input device 616 are configured to display at least a first icon 670, and typically more than one icon. The processor 112 is configured to detect an input from the first input device 614, and to cause a movement of the first icon 670 from the first input device 614 to the second input device 616. The processor 112 may be configured to detect the input from the second input device 616, the processor 112 being configured to cause a movement of the first icon 670 from the second input device 616 to the first input device 614.

In various embodiments of the present invention, the first input device 614 may be configured to move a first icon 670 from the first input device 614 to the second input device 616, where a second icon 672 displayed on the second input device 616 may be replaced by the first icon 670. In this example embodiment the processor 112 is configured to detect the input on the first input device 614 and to replace the second icon 672 with the first icon 670 on the second input device 616. In a further example embodiment, the processor 112 is configured to move the first icon 670 from the first input device 614 to the second input device 616, and to display both the first icon 670 and the second icon 672 on the second input device 616, the processor 112 further configured to display the second icon 672 on the second input device 616 before the first icon 670 is moved. In this example embodiment, the processor 112 is configured to transfer the first icon 670 from the first input device 614 to the second input device 616.

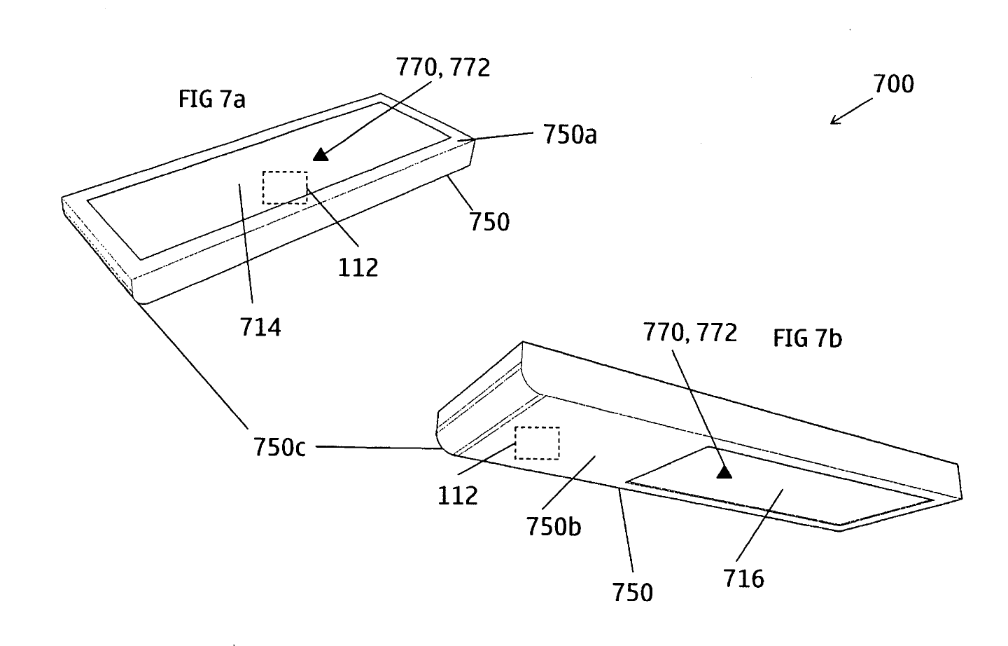

FIGS. 7a and 7b illustrate a perspective view of an apparatus 700 according to various embodiments of the present invention. The apparatus 700 comprises a first housing 750. The apparatus 700 is typical of a mobile phone type device having one housing, these are often referred to as “candybars” or “monoblocks”. The first housing 750 comprises a first input device 714 disposed on a first surface 750a of the first housing 750. The first housing 750 further comprises a second input device 716 disposed on a second surface 750b of the first housing 750. The first surface 750a may be arranged substantially parallel to the second surface 750b as illustrated in FIGS. 7a and 7b, or in alternative embodiments the first surface 750a may be arranged in any other physical way relative to the second surface 750b, for example, the first or second surfaces 750a, 750b may be curved relative to one another over at least part of the whole surface of the first or second surfaces 750a, 750b. The surfaces of the first housing 750 may be curved or shaped in any way, a curved face 750c illustrates this possibility, the curved face 750c providing clarity in FIGS. 7a and 7b such that the first surface 750a and the second surface 750b are clearly illustrated.

The apparatus 700 is such that both the first and second input devices 714, 716 are always visible to the user of the apparatus 700. As described for the previous embodiments the processor 112 is configured to detect an input on the first input device 714, where the first input device 714 may be a touch display screen. The input being a result of the user using his or her finger or a pointer tool to select and physically move a first icon 770 towards a perimeter of the first input device 714. The processor 112 is configured to cause a movement of the first icon 770 towards a perimeter of the first input device 714 in response to the input, and the processor 112 is further configured to move the first icon 770 from the first input device 714 to the second input device 716. This gives the effect that the action frees up space on the first input device 714 to display other icons or to not display anything at all, the first icon 770 may be needed by the user whilst performing other actions on the first input device 714. As previously described above, the first icon 770 may be transferred from the first input device 714 to the second input device 716, or the first icon 770 may replace a second icon 772 on the second input device 716.

The processor 112 is further configured to detect an input on the second input device 716, where the second input device 716 may be a touch display screen. The input being a result of the user using his or her finger or a pointer tool to select and physically move a second icon 772 towards a perimeter of the second input device 716. The processor 112 is configured to cause a movement of the second icon 772 towards a perimeter of the second input device 716 in response to the input, and the processor 112 is further configured to move the second icon 772 from the second input device 716 to the first input device 714. This gives the effect that the action frees up space on the second input device 716 to display other icons or to not display anything at all, the second icon 772 may be needed by the user whilst performing other actions on the second input device 716. As previously described above, the second icon 772 may be transferred from the second input device 716 to the first input device 714, or the second icon 772 may replace a first icon 770 on the first input device 714.

It should be appreciated that in the example embodiments of FIGS. 1, 2, 4, 5 and 6 provided herein, for example as illustrated with reference to FIGS. 6a, 6b, 6c and 6d, that at least one of the first and second icons 670, 672 may be moved from a first input device 614 to a second input device 616 when the apparatus 600 is in the first or closed configuration so that the at least one of the first and second icons 670, 672 are no longer visible to the user of the apparatus 600. When the apparatus 600 is in the second configuration the at least one of the first and second icons 670, 672 are now visible to the user.

It should also be appreciated that whilst example embodiments have outlined that an icon may be transferred between a first and second input device by way of moving the icon towards a perimeter of a first input device, other embodiments by which the icon could be transferred may include moving the icon to a designated area within an area defined by one of the at least first and second input devices.

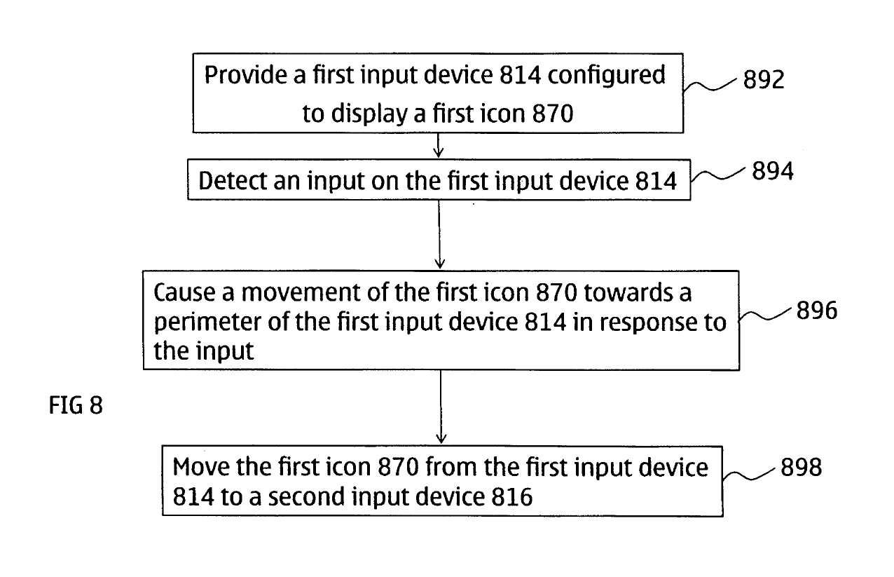

FIG. 8 illustrates a flow diagram of a method of performing the movement of an icon displayed on an apparatus 800 according to various embodiments of the present invention. It should be appreciated that the illustration of a particular order to the blocks does not necessarily imply that there is a required or preferred order for the blocks and the order and arrangement of the block may be varied. Furthermore, it may be possible for some blocks to be omitted.

At block 892, the method includes providing a first input device 814 configured to display a first icon 870. At block 892 the method may include providing a second input device 816 configured to display the first icon 870 and a second icon 872. The first and second input devices 814, 816 may be arranged on any surface or part of the apparatus 800.

At block 894 the method includes detecting an input on the first input device 814. A processor 112, as known in the art, and as described in the previous exemplary embodiments, may be configured to detect the input on the first input device 814. At block 894 the processor 112 may be configured to detect an input on the second input device 816.

At block 896 the method includes causing a movement of the first icon 870 towards a perimeter of the first input device 814 in response to the input. The processor 112 may be configured to cause the movement of the first icon 870 towards a perimeter of the first input device 814. At block 896 the processor 112 may be configured to cause a movement of the second icon 872 towards a perimeter of the second input device 816.

At block 898 the processor 112 is configured to move the first icon 870 from the first input device 814 to a second input device 816. At block 898 the processor may be configured to move the second icon 872 from the second input device 816 to the first input device 814 in response to the input.

Referring now again to FIG. 1, FIG. 1 illustrating a perspective view of an apparatus 100 according to various embodiments of the present invention. The apparatus 100 may comprise a computer program which may reside on and be executed by a processor 112, and in one or more of the memories 118, 120, 122, and 124. The computer program may comprise code for detecting an input on a first input device 114. The first input device 114 may be configured to display a first icon 170 and the code for moving the first icon 170 towards a perimeter of the first input device 114 in response to the input. The code may move the first icon 170 from the first input device 114 to a second input device 116 in response to the input when the computer program is run on the processor 112.

The computer program may be a computer program product comprising a computer-readable medium 120, 122, and 124 bearing computer program code embodied therein for use with a computer.

As discussed above, the apparatus 100 may comprise a computer-readable medium 120, 122, and 124, encoded with instructions that when executed by a computer perform detection of an input on a first icon 170 configured to be displayed on the first input device 114. The instructions may then cause a movement of the first icon 170 towards a perimeter of the first input device 114 in response to the input. The instructions may then cause a movement of the first icon 170 from the first input device 114 to a second input device 116, the second input device 116 being configured to display the first icon 170.

The apparatus 100 may comprise means for processing, means for detecting an input on a first input device 114, on a first icon 170 displayed on the first input device 114, the first input device 114 comprising displaying means for displaying at least the first icon 170. The apparatus 100 may further comprise means for moving the first icon 170 towards a perimeter of the first input device 114 in response to the input. The apparatus 100 may comprise means for moving the first icon 170 from the first input device 114 to a second input device 116, the second input device 116 comprising displaying means for displaying at least the first icon 170. The apparatus 100 may further comprise means for replacing a second icon 172 displayed on the second input device 116 with the first icon 170. The apparatus 100 may comprise at least one of the first and second icons 170, 172 having actuable means.

Although embodiments of the present invention have been described in the preceding paragraphs with reference to various examples, it should be appreciated that modifications to the examples given can be made without departing from the scope of the invention as claimed.

Without in any way limiting the scope, interpretation, or application of the claims appearing below, a technical effect of one or more of the example embodiments disclosed herein is the transformation of a user's input performed on a first input device for moving an icon from the first input device to a second input device by moving the icon towards a perimeter of the first input device. Another technical effect of one or more of the example embodiments disclosed herein is the transformation of a user's input performed on a second input device for moving an icon from the second input device to a first input device by moving the icon towards a perimeter of the second input device. Another technical effect of one or more of the example embodiments disclosed herein is the transformation of a user's input provided by a processor of an apparatus.

Embodiments of the present invention may be implemented in software, hardware, application logic or a combination of software, hardware and application logic. The software, application logic and/or hardware may reside on internal memory storage devices such as random access memory and read only memory, or external memory storage devices such as floppy discs, hard disk drives, CDROMs, DVD-ROMs, or memory sticks. If desired, part of the software, application logic and/or hardware may reside on internal memory storage devices such as random access memory and read only memory, part of the software, application logic and/or hardware may reside on external memory storage devices such as floppy discs, hard disk drives, CDROMs, DVD-ROMs, or memory sticks. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-28. (canceled)

29. An apparatus, comprising
a processor configured to display a first icon on a first input device;
the processor is further configured to detect an input on the first icon and to cause a movement of the first icon towards a perimeter of the first input device in response to the input; and
wherein in response to the detection of the input the processor is further configured to move the first icon from the first input device to a second input device.

30. The apparatus according to claim 29, wherein the second input device is configured to display the first icon and the second icon.

31. The apparatus according to claim 29, wherein the processor is further configured to replace the second icon with the first icon, and the second input device is configured to display only the first icon.

32. The apparatus according to claims 30, wherein the first icon is an actuable icon.

33. The apparatus according to claim 29, wherein at least the first input device is configured to be touch responsive and the input is configured to be a touch input.

34. The apparatus according to claim 29, wherein the second input device comprises at least one mechanical key.

35. An apparatus according to claim 29, further comprising a first housing comprising the processor and the first input device.

36. The apparatus according to claim 35, wherein the apparatus further comprises a second housing.

37. The apparatus according to claim 36, wherein the second housing comprises the second input device.

38. The apparatus according to claims 36, wherein the apparatus further comprises a mechanism coupled to the first and second housing, the mechanism configured to move at least one of the first and second housings relative to the other of the at least one of the first and second housings between a first configuration and a second configuration of the apparatus.

39. The apparatus according to claim 38, wherein the movement reveals at least the first and second input devices to enable a user to provide the touch input to any of the first and second input devices when the apparatus is in the second configuration.

40. The apparatus according to claim 38, wherein the first configuration is a closed configuration of the apparatus, and the second configuration is an open configuration of the apparatus.

41. The apparatus according to claim 35, wherein the first housing further comprises a first surface, and wherein the first surface comprises the first input device and the second input device.

42. The apparatus according to claim 35, wherein the first housing further comprises a first and second surface, and wherein the first surface comprises the first input device and the second surface comprises the second input device.

43. The apparatus according to claim 42, wherein the first surface is a front surface of the apparatus, and the second surface is a rear surface of the apparatus.

44. The apparatus according to claim 29, wherein the apparatus is a portable electronic device.

45. A method, comprising:
displaying a first icon to be displayed on a first input device;
detecting an input on the first icon and causing a movement of the first icon towards a perimeter of the first input device in response to the input, and
in response to the detection of the input moving the first icon from the first input device to a second input device.

46. The method according to claim 45, further comprising configuring the second input device to display the first icon and the second icon.

47. The method according to claim 45, further comprising replacing the second icon with the first icon and displaying on the second input device the first icon.

48. The method according to claim 45, wherein the first icon is an actuable icon.

49. The method according to claims 45, further comprising configuring at least the first input device to be touch responsive and configuring the input to be a touch input.

50. An apparatus, comprising:
a first input device configured to display a first icon;
at least one processor; and
at least one memory including computer program code;
the at least one memory and the computer program code configured to, with the at least one processor, cause the apparatus to perform at least the following:
detection of an input on the first input device;
movement of the first icon towards a perimeter of the first input device in response to the input; and
movement of the first icon from the first input device to a second input device.

51. A computer-readable medium encoded with instructions that, when executed by a computer, perform:
detection of an input on a first icon configured to be displayed on the first input device;
movement of the first icon towards a perimeter of the first input device in response to the input; and
movement of the first icon from the first input device to a second input device, the second input device configured to display the first icon.
